(19) United States
(12) Patent Application Publication
(10) Pub. No.: US 2011/0104563 A1
(43) Pub. Date: May 5, 2011

(54) ELECTROCHEMICAL CELL

(75) Inventors: Robert Christie Galloway, Derbyshire (GB); Roger Neil Bull, Derbyshire (GB)

(73) Assignee: GENERAL ELECTRIC COMPANY, SCHENECTADY, NY (US)

(21) Appl. No.: 12/612,000

(22) Filed: Nov. 4, 2009

(51) Int. Cl. H01M 6/04; H01M 4/58

(52) U.S. Cl. 429/199; 429/218.1; 429/223; 429/231.5; 429/224; 429/221; 252/182.1

(57) ABSTRACT

An electrochemical cell is provided. The electrochemical cell comprises a cathode compartment. The cathode compartment comprises a cathodic metal, a metal halide, and a molten electrolyte. The cathodic metal comprises a high surface area metal powder and a low surface area metal powder. The electrochemical cell also comprises an anode compartment. The anode compartment comprises a molten anodic metal. A method of manufacturing the electrochemical cell is also provided.

### BACKGROUND

1. Technical Field

The invention includes embodiments that relate to an electrochemical cell. The invention includes embodiments that relate to an electrochemical cell with high rate capability. The invention includes embodiments that relate to a method for employing a cathodic material to provide an electrochemical cell with high rate capability.

2. Discussion of Related Art

Recently, with the rapid development of hybrid vehicles, consumer electronic devices, related equipment and communications equipment there is an increased demand placed on the power supply driving these devices. Further equipment such as computers and mobile phones that are rapidly becoming more portable and cordless add to the demand for a suitable power supply. Thus there is a high demand for electrochemical cells that are compact, lightweight and have a high energy density. Also there is a demand for electrochemical cells that can go through a fast charge cycle after every discharge with minimized deterioration on the functioning of the cell, i.e., with minimized increase in internal resistance and minimized time required for charging the cell after every discharge cycle. From this aspect, there is large need and a rush for development for electrochemical cells, having high energy density and that provide increased power output.

It is known in the art that for increase of power, the particle size of an active material constituting the electrode is decreased and voids are formed in an electrode in order to increase the specific surface area of the electrode. However, when the particle size of the active material is decreased, it becomes difficult to form a conduction network for connecting individual active material particles and a collector. Also, for increase of capacitance, it is important to increase the filling density per unit volume, and it is necessary to decrease the porosity in the electrode. Accordingly, high power and high capacity appear in conflict to each other and there is a demand for the development of a technique capable of attaining them simultaneously. Previous metal halide/sodium cells have focused on the lower surface area metal powders, with surface areas of less than about 0.7 square meters per gram. During repeated charging and discharging cycles, the internal resistance of these cells is known to increase. On the other hand employing a filamentary high surface area metal powder having a surface area of greater than about 0.7 square meters per gram decreases the internal resistance of the cells both initially and after repeated cycling. However, simply making a cell out of entirely high surface area metal powder may not be practical, because the tap density of the high surface area metal powder is low and the specific energy of these cells is very limited due to lack of active materials.

It may therefore be desirable to have an electrochemical cell that differs from the cells that are currently available.

### BRIEF DESCRIPTION

In accordance with an embodiment of the invention, an electrochemical cell is provided. The electrochemical cell comprises a cathode compartment. The cathode compartment comprises a cathodic metal, a metal halide, and a molten electrolyte. The cathodic metal comprises a high surface area metal powder and a low surface area metal powder. The electrochemical cell also comprises an anode compartment. The anode compartment comprises a molten anodic metal.

In accordance with an embodiment of the invention, a method is provided. The method comprises a step of providing a cathode compartment. The cathode compartment comprises a cathodic metal, a metal halide, and a molten electrolyte. The cathodic metal comprises a high surface area metal powder and a low surface area metal powder. The method also comprises a step of providing an anode compartment. The anode compartment comprises a molten anodic metal. The method further comprises forming granules by mixing and compacting the high surface area metal powder and a low surface area metal powder; increasing the packing density of the cathodic material; and resulting in lowering the rise in internal resistance and increase in charge capacity of an electrochemical cell.

In accordance with an embodiment of the invention, an electrochemical cell is provided. The electrochemical cell comprises a cathode compartment. The cathode compartment comprises a cathodic metal, a metal halide, and a molten electrolyte. The cathodic metal comprises a high surface area metal powder having a surface area in a range of from about 1.5 square-meters per gram to about 8 square-meters per gram and a low surface area metal powder having a surface area in a range of from about 0.2 square-meters per gram to about 1 square-meter per gram. The electrochemical cell also comprises an anode compartment. The anode compartment comprises a molten anodic metal.

### BRIEF DESCRIPTION OF DRAWINGS

FIG. 1 is a schematic view illustrating an electrochemical cell.

FIG. 2 is a plot of resistance versus charge capacity of electrochemical cells in accordance with an embodiment of the invention.

FIG. 3 is a plot of charge time versus charge capacity of electrochemical cells in accordance with an embodiment of the invention.

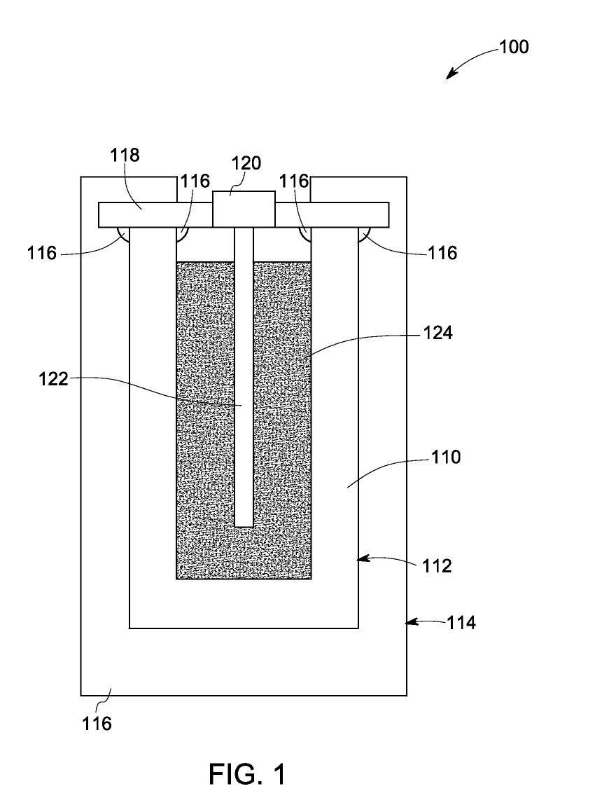

### DETAILED DESCRIPTION

The invention includes embodiments that relate to an electrochemical cell. The invention includes embodiments that relate to an electrochemical cell with high rate capability. The invention includes embodiments that relate to a method for employing a cathodic material to provide an electrochemical cell with high rate capability.

Embodiments of the invention as described herein address the noted shortcomings of the art. The electrochemical cell described herein fills the needs described above by providing an improved electrical performance which may include a lower resistance and a faster charge time. These batteries could potentially offer the improved energy density, power density, lifetime, and cost demanded by the recent rapid development of a variety of equipment mentioned below. To provide a battery with improved capacity, careful characterization of at least the cathode material may be required. As mentioned above for increase of power, the particle size of an active material constituting the electrode is decreased and voids are formed in an electrode in order to increase the specific surface area of the electrode. However, when the particle size of the active material is decreased, it becomes difficult to form a conduction network for connecting individual active material particles and a collector. Further, for increase of capacity, it is important to increase the filling density per unit volume, and it is necessary to decrease the porosity in the electrode. Accordingly, high power and high capacity conflict to each other and there is an urgent demand for the development of a technique capable of attaining them simultaneously. As discussed above, previous metal halide/sodium cells have focused on the lower surface area metal powders, with surface areas of less than about 0.7 square meters per gram. During repeated charging and discharging cycles, the internal resistance of these cells is known to increase. On the other hand employing a filamentary high surface area metal powder having a surface area of greater than about 0.7 square meters per gram provides a cell with a lower initial internal resistance and further decreased internal resistance after repeated cycling.

However, simply making a cell out of entirely high surface area metal powder may not be practical, because the tap density of the high surface area metal powder is low and the specific energy of these cells is very limited due to lack of active materials. For example, when a high surface area material is used the packing density is about 1.7 grams per cubic centimeter. Thereby, the amount of granules that can be used in the same volume of the cell when a high surface area material is employed is about 87 percent of the amount that can be used when a combination of high and low surface area metal powder is employed. So the cell that uses only high surface area material would have a lower capacity and lower energy as the amount of metal powder packed in the given volume is less.

As discussed above, the electrochemical cell disclosed herein comprises a cathodic metal comprising a high surface area metal powder and a low surface area metal powder. In one embodiment, a high packing density of granules of about 1.95 grams per cubic centimeter is obtained when a combination of the high surface area metal powder and the low surface area metal powder is employed. In various embodiments, by decreasing the initial internal resistance of the electrochemical cells, the cells will deliver both higher specific energy and specific power over comparable cells without the high surface area metal powder. Increasing the specific energy and power of the cells results in lower specific costs for any application. In addition, lowering the rise in internal resistance over repeated cycling increases the effective lifetime of the cell. Increasing the effective lifetime of the cell also directly reduces the cost of the cells over time, as they will need to be replaced with a lower frequency.

Approximating language, as used herein throughout the specification and claims, may be applied to modify any quantitative representation that could permissibly vary without resulting in a change in the basic function to which it may be related. Accordingly, a value modified by a term such as “about” is not limited to the precise value specified. In some instances, the approximating language may correspond to the precision of an instrument for measuring the value. As used herein, cathodic material is the material that supplies electrons during charge and is present as part of a redox reaction. Anodic material accepts electrons during charge and is present as part of the redox reaction.

In accordance with an embodiment of the invention, an electrochemical cell is provided. The electrochemical cell comprises a cathode compartment. The cathode compartment comprises a cathodic metal, a metal halide, and a molten electrolyte. The cathodic metal comprises a high surface area metal powder and a low surface area metal powder. The electrochemical cell also comprises an anode compartment. The anode compartment comprises a molten anodic metal.

In one embodiment, as mentioned above the cathodic metal comprises a high surface area metal powder and a low surface area metal powder. In one embodiment, the high surface area metal powder has a surface area in a range of from about 1.5 square-meters per gram to about 8 square-meters per gram. In another embodiment, the high surface area metal powder has a surface area in a range of from about 2.5 square-meters per gram to about 7 square-meters per gram. In yet another embodiment, the high surface area metal powder has a surface area in a range of from about 4 square-meters per gram to about 6 square-meters per gram.

In one embodiment, the high surface area metal powder comprises one or more metals selected from Group V, Group VI, Group VII, and Group VIII of the periodic table. In one embodiment, the high surface area metal powder comprises one or more of nickel, cobalt, iron, manganese, chromium, and vanadium. In one embodiment, the metal forming the high surface area metal powder comprises one or more of nickel and iron.

In one embodiment, the high surface area metal powder comprises particles having an extra fine filamentary, chain-like network of fine sub-particles. In one embodiment, the high surface area metal powder comprises particles having a diameter in the range of about 0.2 micrometers to about 1.0 micrometer. In another embodiment, the high surface area metal powder comprises particles having a diameter in the range of about 0.3 micrometers to about 0.8 micrometers. In yet another embodiment, the high surface area metal powder comprises particles having a diameter in the range of about 0.5 micrometers to about 0.7 micrometers.

In one embodiment, the low surface area metal powder has a surface area in a range of from about 0.2 square-meters per gram to about 1.0 square-meter per gram. In another embodiment, the low surface area metal powder has a surface area in a range of from about 0.3 square-meters per gram to about 0.9 square-meters per gram. In yet another embodiment, the low surface area metal powder has a surface area in a range of from about 0.4 square-meters per gram to about 0.8 square-meters per gram.

In one embodiment, the low surface area metal powder comprises filament-like particles with a diameter of about 2 micrometers to about 8 micrometers. In another embodiment, the low surface area metal powder comprises filament-like particles with a diameter of about 3 micrometers to about 7 micrometers. In yet another embodiment, the low surface area metal powder comprises filament-like particles with a diameter of about 4 micrometers to about 6 micrometers.

In one embodiment, the low surface area metal comprises one or more metals selected from Group VII and Group VIII of the periodic table. In one embodiment, the low surface area metal comprises one or more of nickel and iron. In one embodiment, the low surface area metal comprises nickel.

In one embodiment, the amount of the high surface area metal powder is in a range of about 5 weight percent to about 50 weight percent based on the amount of the low surface area metal powder. In another embodiment, the amount of the high surface area metal powder is in a range of about 10 weight percent to about 30 weight percent based on the amount of the low surface area metal powder. In yet another embodiment, the amount of the high surface area metal powder is in a range of about 15 weight percent to about 25 weight percent based on the amount of the low surface area metal powder.

In one embodiment, the surface area of the metal powder and the average diameter of the particles may be measured using nitrogen adsorption measurements with BET method. BET theory is a rule for the physical adsorption of gas molecules on a solid surface and serves as the basis for an important analysis technique for the measurement of the specific surface area of a material. BET is short hand for the inventors' names: Stephen Brunauer, Paul Hugh Emmett, and Edward Teller, who developed the theory. Primarily, there are two known differences between the high surface area metal powders and the lower surface area: (1) difference in size—the higher surface area powders are smaller in diameter, which is the main source of the high surface area; and (2) difference in shape—the high surface area powders are more filamentary than the low surface area powders.

In one embodiment, the metal halide comprises metals selected from one or more metals selected from Group V, Group VI, Group VII, and Group VIII of the periodic table. In one embodiment, the metal halide comprises one or more of nickel chloride, cobalt chloride, iron chloride, manganese chloride, chromium chloride, and vanadium chloride. In one embodiment, the amount of the metal chloride employed is in a range of from about 20 weight percent to about 40 weight percent based on the total amount of the cathodic metal and the molten electrolyte. In another embodiment, the amount of the metal chloride employed is in a range of from about 22 weight percent to about 38 weight percent based on the total amount of the cathodic metal and the molten electrolyte. In yet another embodiment, the amount of the metal chloride employed is in a range of from about 25 weight percent to about 30 weight percent based on the total amount of the cathodic metal and the molten electrolyte. In certain embodiments, about less than 10 weight percent of a metal fluoride, a metal bromide, or a metal iodide of metals selected from Group V, Group VI, Group VII, and Group VIII of the periodic table may be included along with the metal chloride. The metal fluoride may help in stabilizing the resistance during cycling.

In one embodiment, the molten electrolyte comprises sodium tetrahaloaluminate. In one embodiment, the halogen component of the sodium tetrahaloaluminate may comprise one or more halogens selected from iodine, bromine, and chlorine. In certain embodiments, sodium tetrachloroaluminate mixed haloaluminates having the formula NaAlClₓHA_{y} where x+y=4 may be used, wherein HA comprises one or more of halogens selected from fluorine, bromine, and iodine where the mixed sodium haloaluminate is molten within the operating temperature of the cell. The operating temperature of the cell is in a range of about 160 degrees Celsius to about 450 degrees Celsius.

In one embodiment, the electrochemical cell is a metal-sodium halide rechargeable electrochemical cell. The working of the electrochemical cell may be as described herein. The cathode i.e., the positive electrode contains a mixture of a metal M, a sodium halide NaX, and a molten salt electrolyte. A sodium-conducting ceramic separates the positive and negative electrodes. The negative electrode contains molten sodium. During charging in the positive electrode the metal M is oxidized to the metal halide MX as shown in Equation I and the negative electrode sodium ions are reduced to sodium as shown in Equation II:

M+nNaX→MXₙ+ne⁻ Equation I

nNa⁺+ne⁻→nNa Equation II

When the cell is discharged, reverse reactions occur.

In one embodiment, as known to one skilled in the art the internal resistance of an electrochemical cell may be dependent on the size of the cell. For example, an electrochemical cell having a capacity of about 30 Ampere hours may have an initial charge resistance in a range of about 7 milliOhms to about 8 milliOhms when the cell is initially operated while an electrochemical cell having a capacity of about 10 Ampere hours may have a greater charge resistance in a range of about 20 milliOhms to about 25 milliOhms when the cell is initially operated. On the other hand a cell with a larger capacity of about 250 Ampere hours may have a lower initial resistance when compared to the cell with a capacity of 30 Ampere hours. In one embodiment, the final internal resistance of the electrochemical cell is in a range of from about 20 milliOhms to about 60 milliOhms. In one embodiment, the internal resistance on charge of the cell is in a range of from about 3 milliOhms initially to about 20 milliOhms when the cell is charged.

In one embodiment, the molten anodic metal comprises one or more alkali metals selected from Group I of the periodic table. In one embodiment, the molten anodic metal comprises sodium.

In accordance with an embodiment of the invention, a method is provided. The method comprises a step of providing a cathode compartment. The cathode compartment comprises a cathodic metal, a metal halide, and a molten electrolyte. The cathodic metal comprises a high surface area metal powder and a low surface area metal powder. The method also comprises a step of providing an anode compartment. The anode compartment comprises a molten anodic metal. The method further comprises forming granules by mixing and compacting the high surface area metal powder and a low surface area metal powder; increasing the packing density of the cathodic material; and resulting in lowering the rise in internal resistance and increase in charge capacity of an electrochemical cell.

As known to one skilled in the art, the cathode material forming the positive electrode of an electrochemical cell, for example, a sodium/metal chloride electrochemical cell, may be prepared in the discharged state by forming a blend of components including sodium chloride and a metal powder. In certain embodiments, small amounts of additional additives may be included to improve the electrode. In one embodiment, the additives may comprise a metal for example, aluminum; a metal sulfide, for example zinc sulfide, iron sulfide, or iron disulfide; or an alkali metal halide, for example, sodium iodide or sodium fluoride. In certain embodiments, it has been observed the addition of a metal sulfide or sulfur to the cathode prevents or minimized the growth in size of the nickel particles on cycling. This arrests or minimizes the decrease in the surface area and hence decreases the capacity of the electrochemical cell. On the other hand, the iodide and fluoride may assist in stabilizing the resistance of the cell.

For example, in one embodiment, the electrochemical cell may be assembled without sodium in the anode compartment in an over discharged state, with aluminum in the cathode compartment. When the cell is initially charged, sodium is generated and fills the anode compartment. In addition aluminum helps facilitate full charge by generating porosity in the electrode as it reacts with the sodium chloride present in the cathode compartment to form sodium aluminum chloride. In one embodiment, the blend comprising the sodium chloride, high surface area metal powder, low surface area metal powder, and additives, may be sintered to form the electrode if the additives are compatible with a high temperature reduction sintering process which requires heating the mixture to a temperature of about 800 degrees Celsius in a reducing atmosphere, for example in the presence of hydrogen.

In one embodiment, the blend may be used as such in the powder form. However, the powder route has certain disadvantages in that the powder mixture has a low density of less than about 0.9 grams per cubic centimeter. Furthermore when the powder bed is vibrated during the cell filling process the metal chloride and the metal powder tend to separate because of the large difference in densities, for example the density for sodium chloride is 2.1 grams per cubic centimeter and for nickel is 8.9 grams per cubic centimeter in a sodium chloride/nickel electrode.

The problem of powder separation due to difference in densities may be overcome by compacting the blend without using any binder, and then granulating the compact to give granules with a uniform mixture with an increase in packing density to above 1.9 grams per cubic centimeter. In one embodiment, the compaction of the blend may be effected by passing the blend of powders between rollers at a pressure of about 1000 Newtons per square centimeter to about 1200 Newtons per square centimeter. As used herein the term “compact” means that the blend powder is closely packed together in a dense manner and the process of forming the compact is called “compacting”.

In one embodiment, the yield of granules is about 60 percent. As will be known to one skilled in the art, in various embodiments, the density of granules can be tailored to suit the desired application requirements by using suitable blends of nickel powder, for example, using mixture of Inco 255 powder and Inco Type 210 powder in various proportions.

In accordance with an embodiment of the invention, an electrochemical cell is provided. The electrochemical cell comprises a cathode compartment. The cathode compartment comprises a cathodic metal, a metal halide, and a molten electrolyte. The cathodic metal comprises a high surface area metal powder having a surface area in a range of from about 1.5 square-meters per gram to about 8 square-meters per gram and a low surface area metal powder having a surface area in a range of from about 0.2 square-meters per gram to about 1.0 square-meter per gram. The electrochemical cell also comprises an anode compartment. The anode compartment comprises a molten anodic metal.

### EXAMPLES

The following examples illustrate methods and embodiments in accordance with the invention, and as such should not be construed as imposing limitations upon the claims. These examples demonstrate the manufacture of the catalyst compositions described herein and demonstrate their performance compared with other catalyst compositions that are commercially available.

The high surface area nickel powder used in the examples is Inco Type 210 nickel powder obtained from Vale Inco America's Inc., New Jersey. Surface area measured using BET provides a value of 1.5 square meters per gram to 2.5 square meters per gram. The low surface area nickel powder used in the examples is Inco Type 255 nickel powder obtained from Vale Inco America's Inc., New Jersey. Surface area measured using BET provides a value of 0.7 square meters per gram.

### Examples 1 and 2

### Electrochemical Cells Wherein the Cathode Comprises a High Surface Area Metal Powder and a Low Surface Area Metal Powder

### Preparation of Cathode Material:

The cathode material was prepared by mixing a high surface area nickel powder Inco type 210 nickel powder and a low surface area nickel powder Inco Type 255 nickel powder. The weight percent of Inco type 210 nickel powder employed in Examples 1 and 2 are shown below in Table 1. For Example 1 and Example 2, the components provided in Table 1, i.e., the Inco type 210 nickel powder, the Inco type 255 nickel powder, sodium chloride, sodium fluoride, aluminum and zinc sulfide were blended together using a double cone blender for about 45 minutes to form a uniform blend. The resultant blend was compacted using an Alexanderwerk WP 50 compactor under a roller pressure of about 1000 newtons per square centimeter to about 1200 newtons per square centimeter, combined with a breaker (Remscheid, Germany) to form a compact comprising granules and fines. A vibrating sieve was then used with a screen of mesh size 355 microns to separate granules (particle size range 1500 microns to 355 microns) from the fines (particle size below 355 microns). When vibrated the resultant granules had a tapped density of about 1.95 grams per cubic centimeter. As used herein the phrase “tapped density” refers to the bulk density of the powder after a specified compaction process, usually involving vibration of the container. Yield of the granules is also included in Table 1.

### Comparative Example 1

### Electrochemical Cells Wherein the Cathode Comprises a Low Surface Area Metal Powder

### Preparation of Cathode Material:

The cathode material was prepared by blending together a low surface area nickel powder Inco Type 255 nickel powder, sodium chloride, sodium fluoride, aluminum and zinc sulfide using a double cone blender for about 45 minutes to form a uniform blend. The resultant blend was compacted using an Alexanderwerk WP 50 compactor under a roller pressure of about 1000 newtons per square centimeter to about 1200 newtons per square centimeter combined with breaker (Remscheid, Germany) to form a compact comprising granules and fines. A vibrating sieve was then used with a screen of mesh size 355 microns to separate granules (particle size range 1500 microns to 355 microns) from the fines (particle size below 355 microns). When vibrated the resultant granules had a tapped density of about 1.96 grams per cubic centimeter. Yield of the granules is also included in Table 1.

In Comparative Example 1, since only the granules having low surface area i.e., Inco type 255 granules are used, the resultant granules were found to have an average size of less than 355 microns and the yield of the product granules in a first pass was only about 44.2 weight percent. When recompacted in a second pass the yield of granules increased to about 56 percent. The yield of the granules in Example 1 and 2 where 14.4 and 21.6 weight percent Inco type 210 was used was about 58 weight percent and 63 weight percent respectively in the first pass itself. Thus the process is more efficient as the number of recompaction passes is minimized. The cathode material so formed was filled into the cathode compartment of three independent electrochemical cells 100.

TABLE 1

| Example | Comparative | 1 | 2 |
|---|---|---|---|
| Inco type 255 in grams | 138.5 | 118.54 | 108.54 |
| Inco type 210 in grams | 0 | 20 | 30 |
| Sodium chloride in grams | 88.87 | 88.87 | 88.87 |
| Sodium fluoride in grams | 4.31 | 4.31 | 4.31 |
| Aluminum in grams | 1.15 | 1.15 | 1.15 |
| Sodium iodide in grams | 0.44 | 0.44 | 0.44 |
| Zinc sulfide in grams | 6.9 | 6.9 | 6.9 |
| Total weight in grams | 240 | 240 | 240 |
| Granule yield weight percent | 44.2 | 58 | 63 |
| Tap Density | 1.96 | 1.95 | 1.95 |
| Sodium aluminum chloride in | 126 | 126 | 126 |
| grams | | | |

### Construction of an Electrochemical Cell:

An electrochemical cell 100 was constructed by inserting a beta alumina tube 110 with tight fitting metal shims (not shown in figure) on its outer-side 112 into a steel cell case 114. The beta alumina tube 110 was joined by a glass seal 116 to an alpha alumina collar 118. the alpha alumina collar 118 in turn was itself joined to a metal collar 120. The beta alumina tube 110 was held in position in the cell case 114 by welding the metal collar 120 to the cell case 114. A nickel current collector 122 was fixed inside the beta alumina tube 110 and welded to an inner collar (not shown in figure) joined to the beta alumina tube 110. Cathodic material granules 124 made as described above (in Examples 1 and 2, and Comparative Example 1) were independently loaded into different electrochemical cells in the beta alumina tube 110 by vibration. The granules were then dried at 300 degrees Celsius under vacuum before loading with molten sodium tetrachloroaluminate (amount included in Table 1) by vacuum impregnation. Finally the positive electrode was sealed off by welding a cap over the orifice at the top of the cell. Ten cells were joined in series to make up a module and placed in a heated bath. The bath was heated to about 295 degrees Celsius and the cells were subjected to the cycle regime indicated in Table 2.

TABLE 2

| | Charging amperes/volts | Discharging amperes |
|---|---|---|
| Cycle | for ampere hours | for ampere hours |
| 1 to 10 normal cycling | 10 A/26.7 V/0.5 A | 16 A for 32 Ah |
| I U I charging | | |
| After Cycle 11 fast | 30 A/30.5 V for 22 Ah | 32 A for 22 Ah |
| cycling from 32 Ah | | |
| discharge | | |
| I U charging | | |

As used herein the phrase “IUI charging” refers to a charging profile used for fast charging standard flooded lead acid batteries from particular manufacturers. In this technique, initially the battery is charged at a constant current (I) rate until the cell voltage reaches a preset value—normally a voltage near to that at which gassing occurs. This first part of the charging cycle is known as the bulk charge phase. When the preset voltage has been reached, the charger switches into the constant voltage (U) phase and the current drawn by the battery will gradually drop until it reaches another preset level. This second part of the cycle completes the normal charging of the battery at a slowly diminishing rate. Finally the charger switches again into the constant current mode (I) and the voltage continues to rise up to a new higher preset limit when the charger is switched off. This last phase is used to equalize the charge on the individual cells in the battery to maximize battery life. In case of IU charging the batter is subjected only to the first two steps of charging at constant (I) and charging at constant voltage (U).

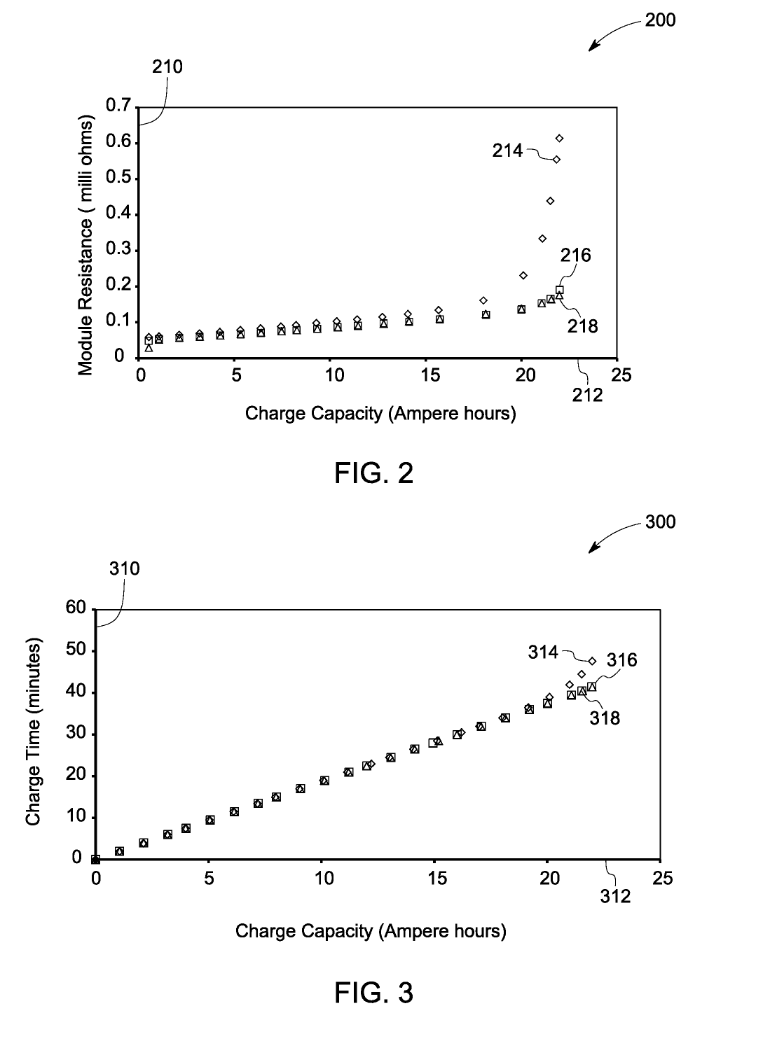

Referring to FIG. 2, a plot 200 of module resistance on the y-axis 210 versus charge capacity on the x-axis 212 of electrochemical cells is provided. The curves 214, 216 and 218 represent the change in resistance with respect to the change in charge capacity for the cells prepared in Comparative Example 1 and in Examples 1 and 2 respectively. The curve 214 indicates that in the Comparative Example 1 where the cathode material only includes low surface area metal powder Valelnco nickel 255, the resistance increases rapidly towards the end of the 22 ampere hour charge. The curves 216 and 218 indicate that in Example 2 and 3 where a combination of high and low surface area metal powder Valelnco 210 and Vale Inco 255 have been used the resistance remains low as the charge increases even towards the end of the 22 ampere hour charge.

Referring to FIG. 3, a plot 300 of charge time 310 versus charge capacity 312 of electrochemical cells is provided. The curves 314, 316 and 318 represent the change in charge time with respect to the change in charge capacity for the cells prepared in Comparative Example 1 and in Examples 1 and 2 respectively. The curve 314 indicates that in the Comparative Example 1 where the cathode material only includes low surface area metal powder Valelnco nickel 255, the charge time to achieve the full 22 ampere hour of charge is above 47 minutes. The curves 316 and 318 indicate that in Example 2 and 3 where a combination of high and low surface area metal powder Valelnco 210 and Vale Inco 255 have been used the charge time to achieve the full 22 ampere hour charge capacity has been reduced to 41 minutes.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electrochemical cell, comprising:
a cathode compartment, wherein the cathode compartment comprises a cathodic metal, a metal halide, and a molten electrolyte, and wherein the cathodic metal comprises a high surface area metal powder and a low surface area metal powder; and
an anode compartment, wherein the anode compartment comprises a molten anodic metal.

2. The electrochemical cell defined in claim 1, wherein the high surface area metal powder has a surface area in a range of from about 1.5 square-meters per gram to about 8 square-meters per gram.

3. The electrochemical cell defined in claim 1, wherein the high surface area metal powder comprises particles having a diameter in the range of about 0.2 micrometers to about 1.0 micrometer

4. The electrochemical cell defined in claim 1, wherein the high surface area metal powder comprises one or more metals selected from the group consisting of Group V, Group VI, Group VII, and Group VIII of the periodic table.

5. The electrochemical cell defined in claim 1, wherein the high surface area metal powder comprises one or more metals selected from nickel, cobalt, iron, manganese, chromium, and vanadium.

6. The electrochemical cell defined in claim 1, wherein the high surface area metal is selected from the group consisting of nickel and iron.

7. The electrochemical cell defined in claim 1, wherein the low surface area metal powder has a surface area in a range of from about 0.2 square-meters per gram to about 1.0 square-meter per gram.

8. The electrochemical cell defined in claim 1, wherein the low surface area metal powder comprises particles having a diameter in the range of about 2 micrometers to about 8 micrometers.

9. The electrochemical cell defined in claim 1, wherein the low surface area metal comprises one or more metals selected from the group consisting of Group VII and Group VIII of the periodic table.

10. The electrochemical cell defined in claim 1, wherein the low surface area metal comprises one or more of nickel and iron.

11. The electrochemical cell defined in claim 1, wherein the amount of the high surface area metal powder is in a range of about 5 weight percent to about 50 weight percent based on the amount of the low surface area metal powder.

12. The electrochemical cell defined in claim 1, wherein the metal halide comprises one or more of nickel chloride, cobalt chloride, iron chloride, manganese chloride, chromium chloride, and vanadium chloride.

13. The electrochemical cell defined in claim 1, wherein the molten electrolyte comprises a sodium tetrahaloaluminate, wherein the halogen component comprises one or more of iodine, bromine, and chlorine.

14. The electrochemical cell defined in claim 1, wherein the internal resistance of the cell on charge is in a range of from about 3 milliOhms at the beginning of the charge to about 20 milliOhms when the cell is completely charged.

15. The electrochemical cell defined in claim 1, wherein the molten anodic metal comprises one or more alkali metals selected from Group I of the periodic table.

16. The electrochemical cell defined in claim 1, wherein the molten anodic metal comprises sodium.

17. A method comprising:
providing a cathode compartment, wherein the cathode compartment comprises a cathodic metal, a metal halide, and a molten electrolyte, and wherein the cathodic metal comprises a high surface area metal powder and a low surface area metal powder; and
providing an anode compartment, wherein the anode compartment comprises a molten anodic metal;
forming granules by mixing and compacting the high surface area metal powder and the low surface area metal powder;
increasing the packing density of the cathodic material; and
resulting in lowering the rise in internal resistance and increase in charge capacity of an electrochemical cell.

18. The method defined in claim 17, wherein the high surface area metal powder has a surface area in a range of from about 1.5 square-meters per gram to about 8 square-meters per gram.

19. The method defined in claim 17, wherein the high surface area metal powder comprises particles having a diameter in the range of about 0.5 micrometers to about 1.0 micrometer.

20. The method cell defined in claim 17, wherein the high surface area metal is selected from the group consisting of nickel and iron.

21. The method defined in claim 17, wherein the low surface area metal powder has a surface area in a range of from about 0.2 square-meters per gram to about 1.0 square-meter per gram.

22. The method defined in claim 17, wherein the low surface area metal powder comprises particles having a diameter in the range of about 2 micrometers to about 8 micrometers.

23. The method defined in claim 17, wherein the low surface area metal is selected from the group consisting of nickel and iron.

24. An electrochemical cell, comprising:
a cathode compartment, wherein the cathode compartment comprises a cathodic metal, a metal halide, and a molten electrolyte, and wherein the cathodic metal comprises a high surface area metal powder having a surface area in a range of from about 1.5 square-meters per gram to about 8 square-meters per gram and a low surface area metal powder having a surface area in a range of from about 0.2 square-meters per gram to about 1.0 square-meter per gram; and
an anode compartment, wherein the anode compartment comprises a molten anodic metal.
